(19) United States
(12) Patent Application Publication
(10) Pub. No.: US 2011/0161716 A1
(43) Pub. Date: Jun. 30, 2011

(54) SYSTEMS, METHODS, AND APPARATUSES FOR PROVIDING ACCESS TO REAL TIME INFORMATION

(76) Inventors: Jani Hyvönen, Tampere (FI); Jukka Hissa, Tampere (FI); Jari Muurinen, Pemio (FI)

(21) Appl. No.: 12/651,048

(22) Filed: Dec. 31, 2009

(51) Int. Cl. G06F 1/14

(52) U.S. Cl. 713/502

(57) ABSTRACT

Methods, apparatuses, and systems are provided for providing access to real time information. A method may include running an application on top of a virtual platform. The method may further include determining a real time. The real time may define a non-simulation time that is maintained independently of the virtual platform such that the real time is not affected by performance of the virtual platform or of the application running on top of the virtual platform. The method may additionally include providing the determined real time for access by the application. Corresponding apparatuses and systems are also provided.

### TECHNOLOGICAL FIELD

Embodiments of the present invention relate generally to software development technology and, more particularly, relate to systems, methods, and apparatuses for providing access to real time information.

### BACKGROUND

The modern computing era has brought about a tremendous expansion in computing platform technology, resulting in a tremendous increase in the number of computing platforms and variations therein. This expansion in computing platform technology has been particularly dramatic in mobile computing devices, many of which now possess a degree of computing power and implement functionality found only a few years ago in the most powerful desktop computers. However, modern computing platforms possess a variety of hardware specifications. Further, many computing platforms implement manufacturer specific or other proprietary operating systems that may differ quite substantially from Microsoft Windows® and other operating systems common to desktop computing platforms. Consequently, applications developed for one computing platform may not operate as intended on a second computing platform that may have a different hardware specification and/or implement a different operating system.

Testing is accordingly becoming an even more crucial part of software development to ensure that an application in development runs properly on the computing platform(s) for which it is being developed. However, application development is often carried out on a platform different from that on which the application is intended to be implemented. For example, software developers may develop an application intended for implementation on a mobile telephone device running a proprietary operating system on a desktop computer running Microsoft Windows®, Linux, or other desktop operating system. Accordingly, in order to test an application on the platform on which it is being developed, a software-defined virtual platform may be used to emulate the computing platform on which the application is intended for use.

### BRIEF SUMMARY OF SOME EXAMPLES OF THE INVENTION

Systems, methods, apparatuses, and computer program products for providing access to real time information are herein provided. The systems, methods, apparatuses, and computer program products provided in accordance with embodiments of the invention may provide several advantages to computing devices and computing device users. In this regard, embodiments of the invention may be particularly beneficial in the area of software development in which an application is being run on top of a virtual platform. Some embodiments of the invention provide for determining a real time defining a non-simulation time that is maintained independently of the virtual platform such that the real time is not affected by performance of one or more of a virtual platform or an application running on top of the virtual platform. In this regard, the real time may be maintained by a host operating system on top of which the virtual platform is run or by a computing device external to the device on which the virtual platform is run such that the real time is not subjected to any slow down that may affect a simulation clock run on top of the virtual platform.

Some embodiments of the invention provide a determined real time for access by an application running on top of a virtual platform such that the real time may be used to more accurately evaluate performance of the application. For example, embodiments of the invention allow a more accurate calculation of application performance in terms of millions of instructions per second (MIPS) or other measure of application performance. In this regard, the rate of elapse of the real time maintained independently of the virtual platform by which application performance may be measured in accordance with embodiments of the invention is not affected by performance of the virtual platform, which may slow a rate of elapse of a simulated clock or timer run on top of the virtual platform.

In a first example embodiment, a method is provided, which comprises running an application on top of a virtual platform. The method of this embodiment further comprises determining a real time. The determined real time of this embodiment defines a non-simulation time that is maintained independently of the virtual platform such that the real time is not affected by performance of the virtual platform or of the application running on top of the virtual platform. The method of this embodiment additionally comprises providing the determined real time for access by the application.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least run an application on top of a virtual platform. The at least one memory and stored computer program code are configured to, with the at least one processor, further cause the apparatus of this embodiment to determine a real time. The determined real time of this embodiment defines a non-simulation time that is maintained independently of the virtual platform such that the real time is not affected by performance of the virtual platform or of the application running on top of the virtual platform. The at least one memory and stored computer program code are configured to, with the at least one processor, additionally cause the apparatus of this embodiment to provide the determined real time for access by the application.

In another example embodiment, a computer program product is provided. The computer program product of this embodiment includes at least one computer-readable storage medium having computer-readable program instructions stored therein. The program instructions of this embodiment comprise program instructions configured to run an application on top of a virtual platform. The program instructions of this embodiment further comprise program instructions configured to determine a real time. The determined real time of this embodiment defines a non-simulation time that is maintained independently of the virtual platform such that the real time is not affected by performance of the virtual platform or of the application running on top of the virtual platform. The program instructions of this embodiment also comprise program instructions configured to provide the determined real time for access by the application.

In another example embodiment, an apparatus is provided that comprises means for running an application on top of a virtual platform. The apparatus of this embodiment further comprises means for determining a real time. The determined real time of this embodiment defines a non-simulation time that is maintained independently of the virtual platform such that the real time is not affected by performance of the virtual platform or of the application running on top of the virtual platform. The apparatus of this embodiment additionally comprises means for providing the determined real time for access by the application.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system layer diagram of layers that may be implemented on a system for simulation of an application according to an embodiment of the invention;

FIG. 2 illustrates a block diagram of an apparatus 202 for providing access to real time information according to an example embodiment of the present invention;

FIG. 3 illustrates a system for providing access to real time information according to an example embodiment of the present invention;

FIG. 4 illustrates a signaling diagram of signals that may be exchanged between elements of the system of FIG. 3 in accordance with an example embodiment of the present invention;

FIG. 5 illustrates a system for providing access to real time information according to an example embodiment of the present invention;

FIG. 6 illustrates a signaling diagram of signals that may be exchanged between elements of the system of FIG. 5 in accordance with an example embodiment of the present invention;

FIG. 7 illustrates a system for providing access to real time information according to an example embodiment of the present invention;

FIG. 8 illustrates a signaling diagram of signals that may be exchanged between elements of the system of FIG. 7 in accordance with an example embodiment of the present invention; and

FIG. 9 illustrates a flowchart according to an example method for providing access to real time information according to an example embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

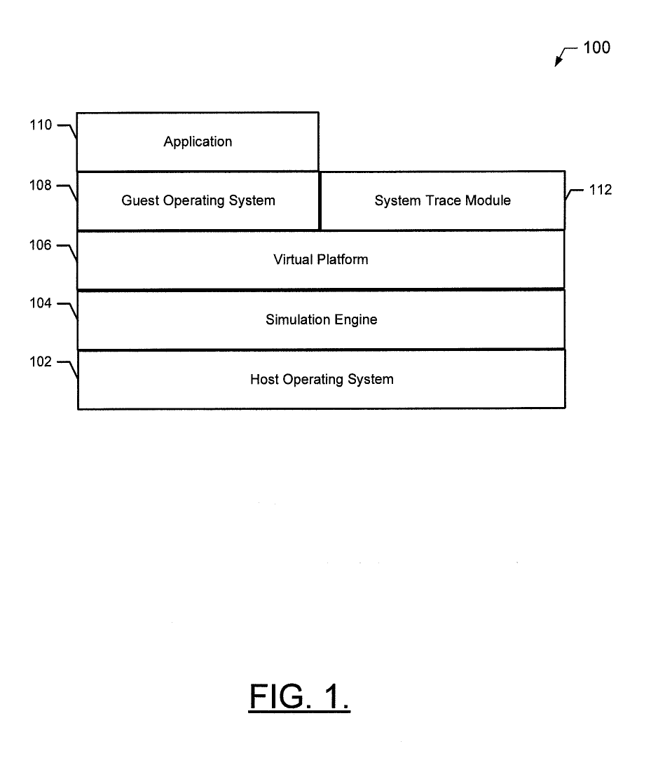

FIG. 1 illustrates a system layer diagram 100 of system layers that may be implemented on a system for simulation of an application (e.g., the application 110) according to an embodiment of the invention. Such an application may comprise any type of application, such as, for example, a program, operating system, applet, code segment, and/or the like. As illustrated in FIG. 1, the system layer diagram 100 includes a host operating system 102. The host operating system 102 of the embodiment illustrated in FIG. 1 comprises an operating system running on a computer. The host operating system may be utilized for testing the application. In this regard, the host operating system may be utilized for executing/running a simulation engine (e.g., the simulation engine 104). The host operating system 102 may, for example, comprise any version of a Microsoft Windows® operating system, a Linux operating system, a Unix operating system, an Apple Macintosh® operating system, or the like. The system layer diagram 100 further comprises a simulation engine 104. The simulation engine 104 may comprise any application configured to run on top of the host operating system 102 to enable implementation and/or execution of a virtual platform. The simulation engine 104 may, for example, comprise Virtio Innovator, Eclipse, ARM System Generator, or other simulation engine.

The system layer diagram 100 further comprises a virtual platform 106. The virtual platform 106 may comprise an emulation of any computing platform. The virtual platform 106 may be at least partially implemented via software. The virtual platform 106 may be implemented and/or executed using the simulation engine 104. Alternatively, in some embodiments, the simulation engine 104 may be eliminated and the virtual platform 106 may be configured to run directly on top of the host operating system 102. The virtual platform 106 may be configured to emulate at least a portion of the hardware specifications of any computing platform and may, for example, emulate one or more processors, one or more application-specific integrated circuits (ASICs), one or more logic gates, and/or the like.

The system layer diagram 100 further includes a guest operating system 108 that is run on top of the virtual platform 106. In this regard the guest operating system 108 may be run on top of the virtual platform 106 as if it were being run on the physical computing platform which is emulated by the virtual platform 106. The guest operating system 108 may comprise s60 Symbian eshell, Linux, or other operating system that may be run on the physical computing platform which is emulated by the virtual platform 106. The system layer diagram 100 further includes an application 110. The application 110 may be run on top of the guest operating system 108. It will be appreciated that the application 110 may also be considered to be run on top of the virtual platform 106, as the guest operating system 108 on top of which the application 110 is run on top of the virtual platform 106. In some embodiments, however, the guest operating system 108 may be eliminated and the application 110 may be run directly on top of the virtual platform 106.

The system layer diagram 100 also includes a system trace module (STM) 112. The STM 112 may be run on top of and/or at least partially integrated into the virtual platform 106. Accordingly, it will be appreciated that although illustrated in FIG. 1 as a separate layer or component, in some embodiments, the STM 112 may be integrated into the virtual platform 106. The STM 112 may be configured to trace and/or otherwise monitor an application, such as the application 110, which is run on top of the virtual platform 106. In this regard, the STM 112 may be configured to monitor and/or record performance of the application 110, such as in terms of a number of instructions executed.

According to some embodiments of the invention, a host operating system, such as the host operating system 102 may be configured to maintain and/or access what is referred to as a “real time.” The real time may comprise a non-simulation time in that the real time may be maintained at a hardware level on a dedicated clock or timer on an apparatus on which the virtual platform is run.

In contrast, a “simulation time” may be maintained by an emulated clock or timer run on top of a virtual platform, such as the virtual platform 106. Thus, unlike real time, simulation time is dependent on the performance (e.g., speed) of the virtual platform and/or application(s) run on top of the virtual platform. Simulation time may therefore be subject to a delay or slow down in rate of elapse as compared to real time. In this regard, a degree of complexity involved in emulating the hardware emulated by a virtual platform may cause a slow down in a simulation rate of an entire simulation comprising the virtual platform and any applications (e.g., simulation time or clock, application 110, guest operating system 108, and/or the like) run on top of the virtual platform. A slow down in the simulation rate of the simulation may slow a rate of elapse of the simulation time such that the simulation time does not elapse at the same rate as real time. Accordingly, simulation time may not correspond to real time.

Heretofore, real time has not been accessible to an application (e.g., the application 110, guest operating system 108, and/or the like) running on top of a virtual platform (e.g., the virtual platform 106). Therefore, effectively evaluating the performance of an application simulation has been difficult, as a performance evaluation made using simulation time may not be accurate due to the dependency of simulation time on the performance of a virtual platform on which the application simulation is run. Further attempts to evaluate the performance of an application simulation using an externally maintained time, such as by using a wall clock or other means may introduce human error to the evaluation as a start and stop time of the clock may not be synchronized to the start and stop times of the application simulation.

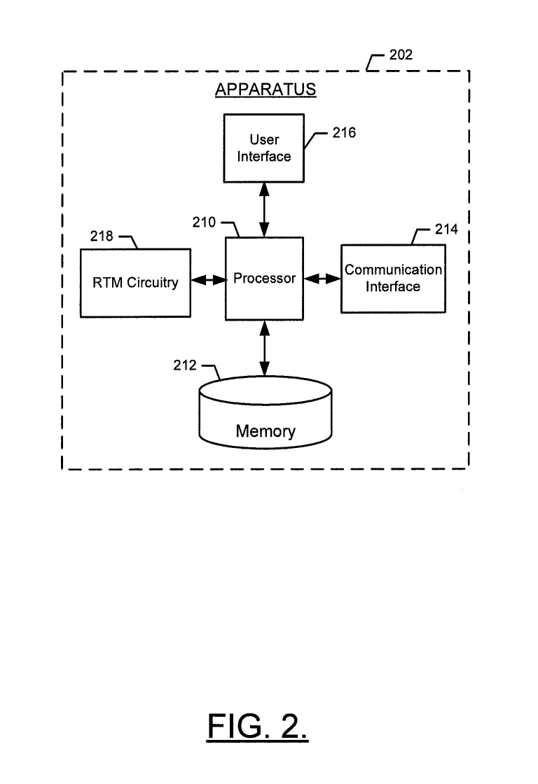

Embodiments of the invention provide systems, methods, apparatuses, and computer program products for providing access to real time information. In this regard, FIG. 2 illustrates a block diagram of an apparatus 202 for providing access to real time information according to an example embodiment of the present invention. It will be appreciated that the apparatus 202 as well as the illustrations of other figures are each provided as an example of one embodiment of the invention and should not be construed to narrow the scope or spirit of the invention in any way. In this regard, the scope of the invention encompasses many potential embodiments in addition to those illustrated and described herein. As such, while FIG. 2 illustrates one example of a configuration of an apparatus for providing access to real time information according to an example embodiment of the present invention, numerous other configurations may also be used to implement embodiments of the present invention.

The apparatus 202 may comprise any computing device configured to implement one or more of the layers of the system layer diagram 100. In this regard, the apparatus 202 may be configured to serve as a platform for simulation and/or testing of an application. The apparatus 202 may be embodied as any computing device, such as, for example, a desktop computer, laptop computer, server, mobile terminal, mobile computer, mobile phone, mobile communication device, game device, digital camera/camcorder, audio/video player, television device, radio receiver, digital video recorder, positioning device, any combination thereof, and/or the like.

In the example embodiment illustrated in FIG. 2, the apparatus 202 includes various means, such as a processor 210, memory 212, communication interface 214, user interface 216, and real time module (RTM) circuitry 218 for performing the various functions herein described. These means of the user apparatus 202 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 212) that is executable by a suitably configured processing device (for example, the processor 210), or some combination thereof.

The processor 210 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 210 comprises a plurality of processors. The plurality of processors may be embodied on a single computing device or may be distributed across a plurality of computing devices in operative communication with each other and collectively configured to function as the apparatus 202. The plurality of processors may be in operative communication with each other and may be collectively configured to perform one or more functionalities of the apparatus 202 as described herein. In an example embodiment, the processor 210 is configured to execute instructions stored in the memory 212 or otherwise accessible to the processor 210. These instructions, when executed by the processor 210, may cause the apparatus 202 to perform one or more of the functionalities of the apparatus 202 as described herein. As such, whether configured by hardware or software methods, or by a combination thereof, the processor 210 may comprise an entity capable of performing operations according to embodiments of the present invention while configured accordingly. Thus, for example, when the processor 210 is embodied as an ASIC, FPGA or the like, the processor 210 may comprise specifically configured hardware for conducting one or more operations described herein. Alternatively, as another example, when the processor 210 is embodied as an executor of instructions, such as may be stored in the memory 212, the instructions may specifically configure the processor 210 to perform one or more algorithms and operations described herein.

The memory 212 may comprise, for example, volatile memory, non-volatile memory, or some combination thereof. Although illustrated in FIG. 2 as a single memory, the memory 212 may comprise a plurality of memories. The plurality of memories may be embodied on a single apparatus or may be distributed across a plurality of computing devices in operative communication with each other and collectively configured to function as the apparatus 202. In various embodiments, the memory 212 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 212 may be configured to store information, data, applications, instructions, or the like for enabling the apparatus 202 to carry out various functions in accordance with example embodiments of the present invention. For example, in at least some embodiments, the memory 212 is configured to buffer input data for processing by the processor 210. Additionally or alternatively, in at least some embodiments, the memory 212 is configured to store program instructions for execution by the processor 210. The memory 212 may store information in the form of static and/or dynamic information. This stored information may be stored and/or used by RTM circuitry 218 during the course of performing its functionalities.

The communication interface 214 may be embodied as any device or means embodied in circuitry, hardware, a computer program product comprising computer readable program instructions stored on a computer readable medium (for example, the memory 212) and executed by a processing device (for example, the processor 210), or a combination thereof that is configured to receive and/or transmit data from/to another computing device, such as, for example, a trace box. In at least one embodiment, the communication interface 214 is at least partially embodied as or otherwise controlled by the processor 210. In this regard, the communication interface 214 may be in communication with the processor 210, such as via a bus. The communication interface 214 may include, for example, an antenna, a transmitter, a receiver, a transceiver and/or supporting hardware or software for enabling communications with another computing device. The communication interface 214 may be configured to receive and/or transmit data using any protocol that may be used for communications between the apparatus 202 and another computing device. For example, the communication interface 214 may be configured to receive and/or transmit data over a network interface (e.g., a wireline network, wireless network, some combination thereof, or the like), a wired direct link (e.g., a serial port connection, universal serial bus port connection, parallel port connection, and/or the like), a wireless direct link (e.g., a Bluetooth connection, wireless universal serial bus port connection, radio frequency connection, and/or the like), and/or the like. The communication interface 214 may additionally be in communication with the memory 212, user interface 216, and/or RTM circuitry 218, such as via a bus.

The user interface 216 may be in communication with the processor 210 to receive an indication of a user input and/or to provide an audible, visual, mechanical, or other output to a user. As such, the user interface 216 may include, for example, a keyboard, a mouse, a joystick, a display, a touch screen display, a microphone, a speaker, and/or other input/output mechanisms. The user interface 216 may be in communication with the memory 212, communication interface 214, and/or RTM circuitry 218, such as via a bus.

The RTM circuitry 218 may be embodied as various means, such as circuitry, hardware, a computer program product comprising computer readable program instructions stored on a computer readable medium (for example, the memory 212) and executed by a processing device (for example, the processor 210), or some combination thereof and, in one embodiment, is embodied as or otherwise controlled by the processor 210. In embodiments wherein the RTM circuitry 218 is embodied separately from the processor 210, the RTM circuitry 218 may be in communication with the processor 210. The RTM circuitry 218 may further be in communication with one or more of the memory 212, communication interface 214, or user interface 216, such as via a bus.

The apparatus 202 (e.g., the processor 210 of the apparatus 202) is configured in some embodiments to execute one or more layers of the system layer diagram 100. In this regard, the processor 210 may, for example, be configured to run an application (e.g., the application 110) on top of a virtual platform (e.g., the virtual platform 106). In some embodiments, a guest operating system (e.g., the guest operating system 108) may be run by the processor 210 as an intermediate layer between the application and virtual platform. Regardless, it will be appreciated that where an application is described as being run on top of a virtual platform such description is inclusive both of an application being run directly on top of the virtual platform and of an application being run on top of a guest operating system run on top of the virtual platform.

In at least some embodiments, the RTM circuitry 218 is configured to determine a real time that is maintained independently of the virtual platform. In some embodiments, a host operating system implemented on the apparatus 102 is configured to maintain and/or access the real time. In this regard, the host operating system may be configured to control and/or directly access a real time maintained at a hardware level on a dedicated clock or timer on the apparatus 102. In such embodiments, the RTM circuitry 218 may be configured to determine the real time by communicating with the host operating system to obtain the real time. Alternatively, the RTM circuitry 218 may be configured to determine the real time by communicating with a layer, such as, for example, a simulation engine (e.g., the simulation engine 104), that is run directly on top of the host operating system to obtain the real time. In this regard, a layer run directly on top of the host operating system may be configured to determine the real time from the host operating system and the RTM circuitry 218 may be configured to query that layer to determine the real time.

In some embodiments, the real time is maintained by a computing device, such as, for example, a trace box, that is external to the apparatus 102. In such embodiments, the communication interface 214 may be configured to exchange data with the external computing device over a network, interlink, direct connection, and/or the like. Accordingly, the RTM circuitry 218 may be configured to receive an indication of real time sent to the apparatus 102 by the external computing device and/or may be configured to access the external computing device via the communication interface 214 to determine the real time maintained by the external computing device.

The RTM circuitry 218 may be configured to determine the real time in response to a request originated by an application (e.g., the application 110) run on top of the virtual platform (e.g., the virtual platform 106). In this regard, an application may request the present real time, such as to enable performance evaluation, benchmarking, and/or the like of the application as the application is being run. The RTM circuitry 218 may accordingly be configured to determine the real time in response to such a request.

Additionally or alternatively, the RTM circuitry 218 may be configured to determine the real time periodically, such as at regularly scheduled intervals. In embodiments wherein the RTM circuitry 218 is configured to determine the real time periodically, the RTM circuitry 218 may be configured to maintain an estimated real time clock and synchronize the maintained estimated real time clock with the determined real time. The RTM circuitry 218 may be configured to maintain the estimated real time clock in a reserved or allocated portion of the memory 212. In this regard, the RTM circuitry 218 may comprise hardware and/or a computer program product configured to function as and/or emulate a timer or clock. Since such a timer or clock may be dependent on performance of the virtual platform, the time maintained by the RTM circuitry 218 may comprise an estimated real time and the RTM circuitry 218 may synchronize the estimated real time with a determined real time periodically to improve the accuracy of the estimated real time.

In embodiments wherein the RTM circuitry 218 is configured to maintain an estimated real time clock, the RTM circuitry 218 may comprise a computer program product configured to emulate a hardware block as a component of a virtual platform. In this regard, the portion of the RTM circuitry 218 implemented as a computer program product may comprise a portion of a memory, such as the memory 212, storing program instructions. These program instructions may be run (e.g., by the processor 210) as a component of or on top of the virtual platform. The RTM circuitry 218 may utilize allocated address space within the memory 212 to store real time information, such as, for example, real time information maintained for an estimated real time clock.

The allocated address space may comprise memory space reserved in a hardware Input/Output address space specification for the virtual platform that is reserved specifically for use by the RTM circuitry 218. In this regard, the hardware specification for the virtual platform may include an address space reserved for virtual platform specific usage. One of the use cases for the address space reserved for virtual platform specific usage may comprise real time information service provided by the RTM circuitry 218.

As another alternative, registers for use by the RTM circuitry 218 may be allocated to the RTM circuitry 218 from free address space in the virtual platform during runtime of the virtual platform (e.g., the virtual platform 106). As a further alternative address space may be reserved to the RTM circuitry 118 by a guest operating system (e.g., the guest operating system 108) running on top of the virtual platform (e.g., the virtual platform 106). This address space reserved by the guest operating system may comprise a portion of a memory pool available to the virtual platform. In this regard, the hardware specification for the virtual platform may be configured to delegate real time service input/output address space for use by the RTM circuitry 118 and the guest operating system (e.g., the guest operating system 108) may be configured to reserve this address space so as to exclude it from inclusion in the free memory pool for the guest operating system.

In some embodiments, the RTM circuitry 118 is at least partially embodied as a computer program product comprising a hardware model run on top of a virtual platform (e.g., the virtual platform 106). For example, the RTM circuitry 118 may be at least partially embodied on a system trace module (STM), such as, for example, the system trace module 112. Accordingly, address space and/or other resources needed to facilitate functionality of the RTM circuitry 118 may be reserved or otherwise allocated to the RTM circuitry 118 as part of a specification of the STM or other hardware model.

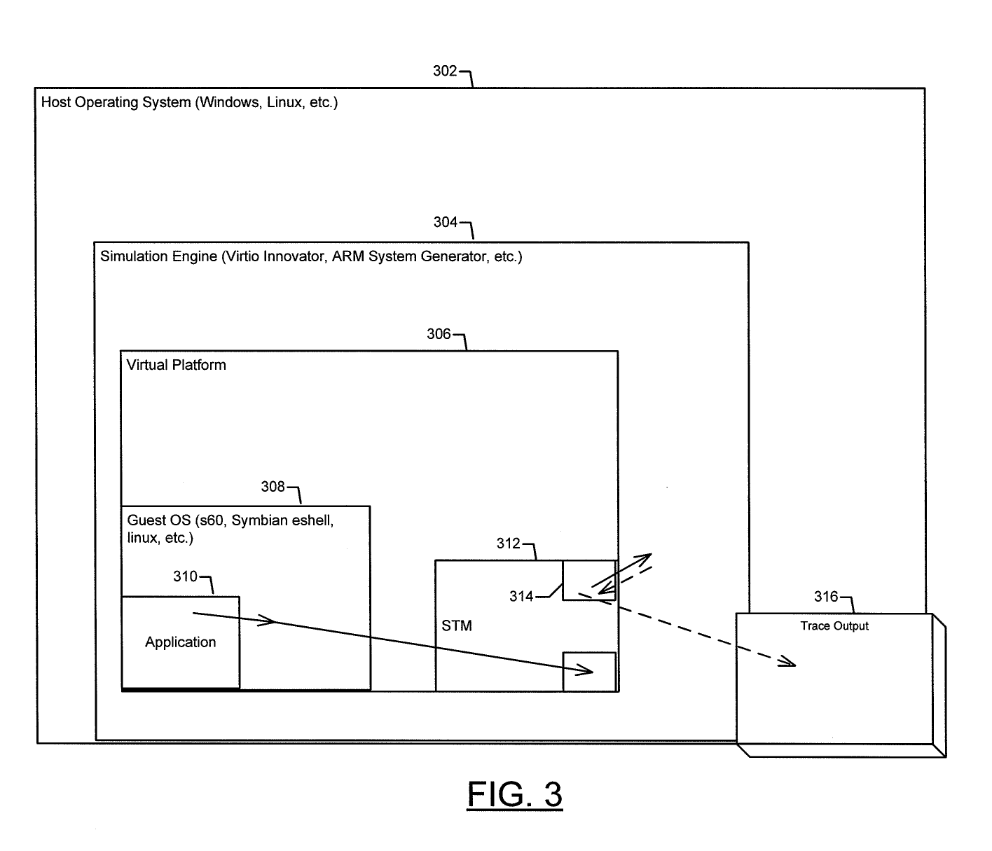

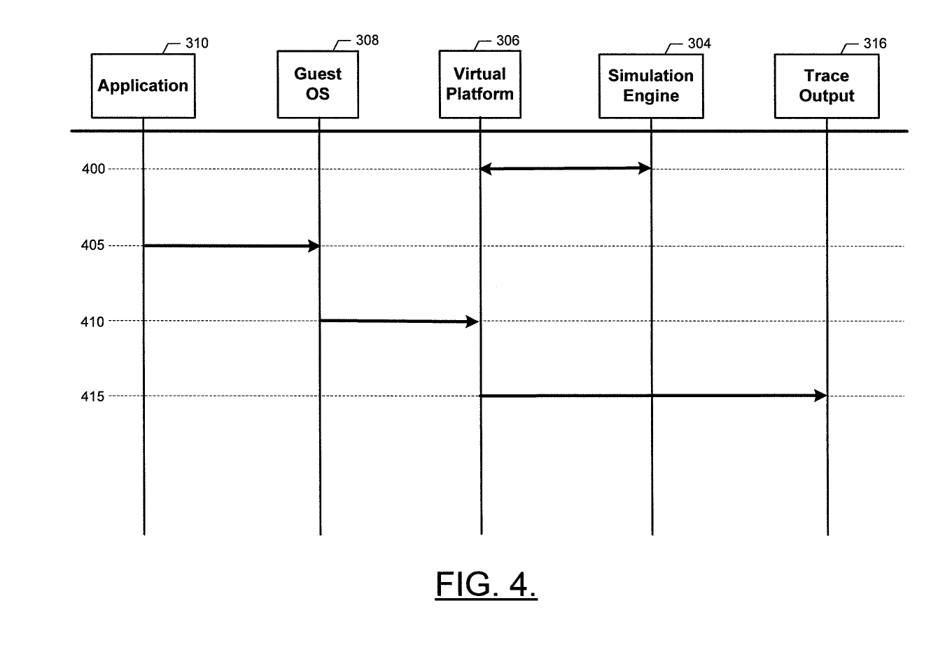

Referring now to FIG. 3, FIG. 3 illustrates a system for providing access to real time information according to an example embodiment of the present invention. The system of FIG. 3 comprises a simulation engine 304 running on top of a host operating system 302. A virtual platform 306 is run on top of the simulation engine 304. A guest operating system 308 is run on top of the virtual platform. The STM 312 may be run on top of the virtual platform 306 or may comprise a functionality, emulated hardware block, and/or the like integrated into the virtual platform 306. An application 310 is run on top of the guest operating system 308. In the embodiment of FIG. 3, a real time module 314 is implemented on the STM 312. The real time module 314 may comprise at least a portion of the RTM circuitry 118 and will be referred to as such by way of example throughout the remainder of the description of FIG. 3 and the description of FIG. 4. The STM 312 is configured to output a trace output 316 based on the performance of the application 310.

FIG. 4 illustrates a signaling diagram of signals that may be exchanged between elements of the system of FIG. 3 in accordance with an example embodiment of the present invention. Operation 400 comprises the virtual platform 306 and simulation engine 304 synchronizing the real time. In this regard, the RTM circuitry 118 may be configured to send a request for real time information to the simulation engine 304, which may have access to real time information via the host operating system 302. The simulation engine 304 may respond by providing real time information to the RTM circuitry 118 through the virtual platform 306 and the RTM circuitry 118 may synchronize an estimated real time maintained by the RTM circuitry 118 using the received real time information.

Operation 405 comprises the application 312 generating a trace using a tracing service provided by the guest operating system 308. The guest operating system 308 conveys the trace to the STM 312, or other virtual platform trace output model, at operation 410. Operation 415 may comprise the RTM circuitry 118 accessing real time information (e.g., the estimated real time maintained by the RTM circuitry 118) and providing the real time for access by the application for stamping the trace with a real time stamp. In this regard, the RTM circuitry 118 and/or STM 312 may stamp the trace with a real time stamp and output the stamped trace, at operation 415. Accordingly, according to some embodiments of the invention, the RTM circuitry 118 may be at least partially embodied on a trace output model, such as an STM, serial port, trace box, or the like such that the trace output model may be configured to stamp and print a real time on a trace. Configuration of whether the trace is stamped by the real time and/or simulation time may comprise static configuration prior to initiation of a simulation or dynamic configuration during runtime of a simulation.

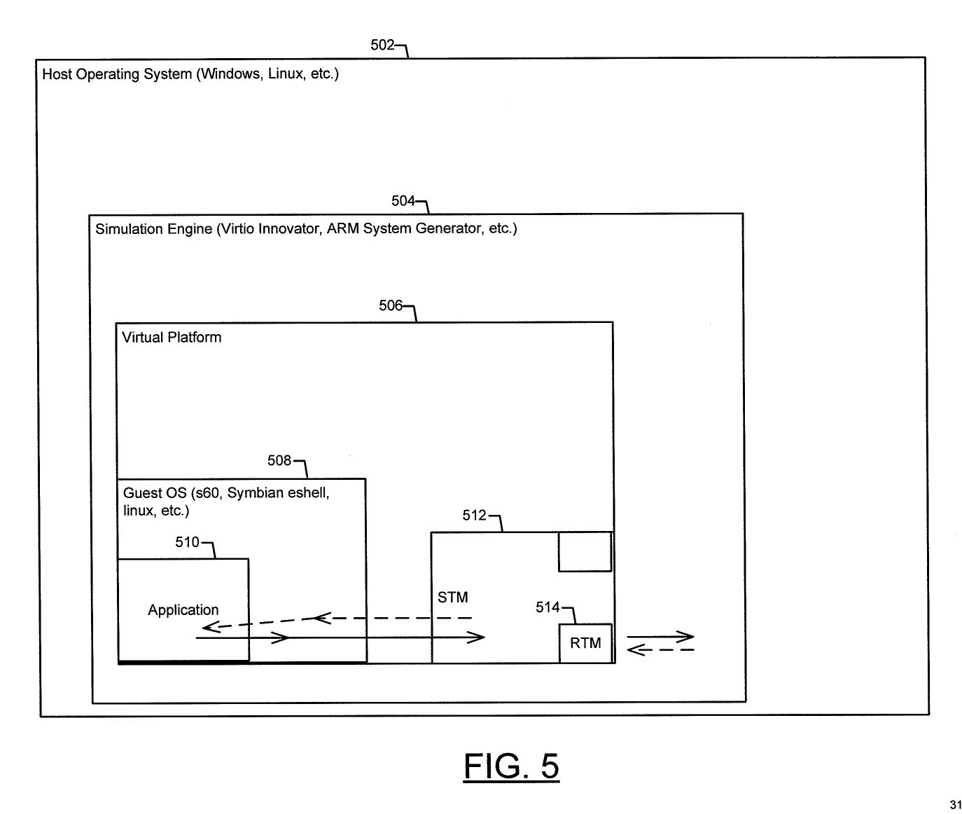

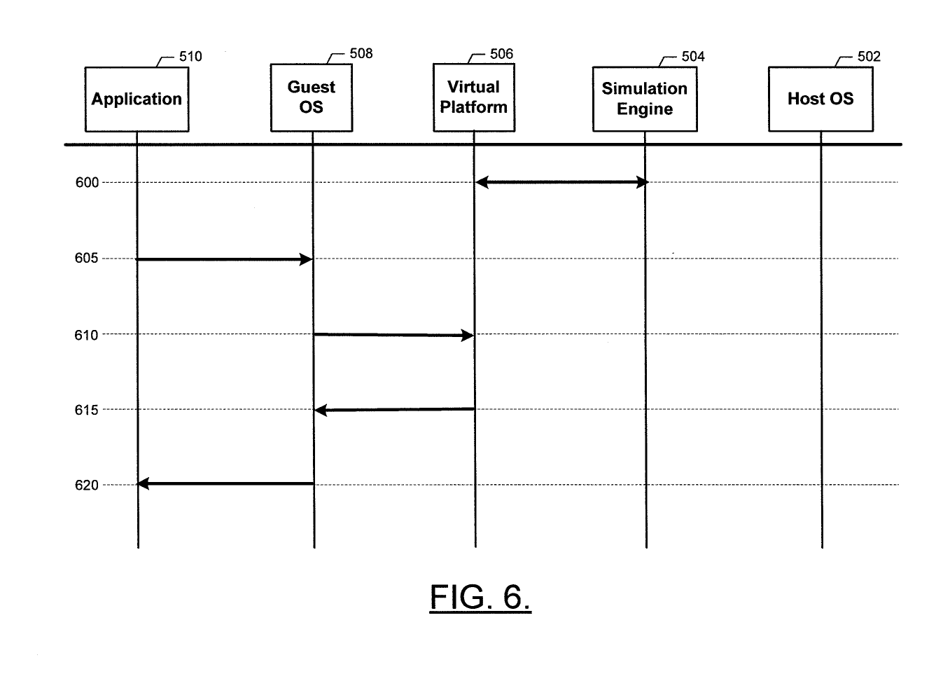

FIG. 5 illustrates a system for providing access to real time information according to an example embodiment of the present invention. The system of FIG. 5 comprises a simulation engine 504 running on top of a host operating system 502. A virtual platform 506 is run on top of the simulation engine 504. A guest operating system 508 is run on top of the virtual platform 506. The STM 512 may be run on top of the virtual platform 506 or may comprise a functionality integrated into the virtual platform 506. An application 510 is run on top of the guest operating system 508. In the embodiment of FIG. 5, a real time module 514 is implemented on the STM 512. The real time module 514 may comprise at least a portion of the RTM circuitry 118 and will be referred to as such by way of example throughout the remainder of the description of FIG. 5 and the description of FIG. 6.

FIG. 6 illustrates a signaling diagram of signals that may be exchanged between elements of the system of FIG. 5 in accordance with an example embodiment of the present invention. Operation 600 comprises the virtual platform 506 and simulation engine 504 synchronizing the real time. In this regard, the RTM circuitry 118 may be configured to send a request for real time information to the simulation engine 504, which may have access to real time information via the host operating system 502. The simulation engine 504 may respond by providing real time information to the RTM circuitry 118 through the virtual platform 506 and the RTM circuitry 118 may synchronize an estimated real time maintained by the RTM circuitry 118 using the received real time information.

During runtime of the application 510, the application 510 may need access to real time information. Accordingly, operation 605 may comprise the application 510 sending a request for real time to the guest operating system 508. The guest operating system 508 may then forward the request to the virtual platform 506, at operation 610. The request may be handled by the RTM circuitry 118, which may determine the real time from the real time maintained by the RTM circuitry 118 through synchronization. The RTM circuitry 118 may then provide the determined real time to the application 510 by sending the real time to the guest operating system 508, at operation 615. The guest operating system 508 may then forward the real time to the application 510, at operation 620.

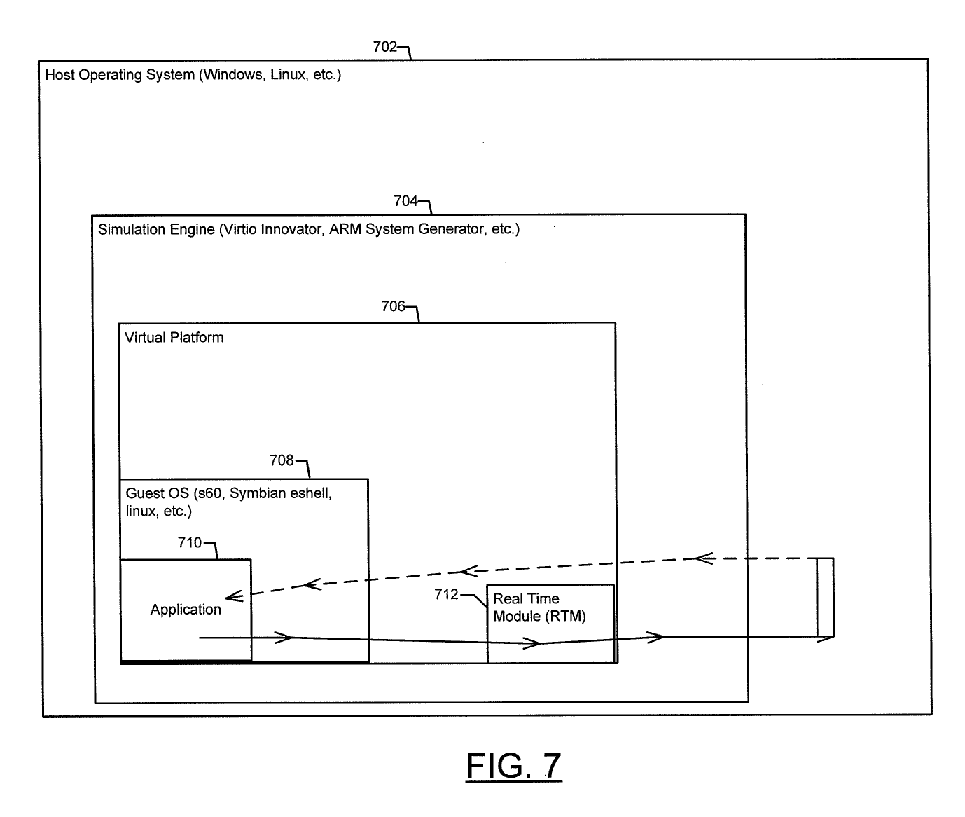

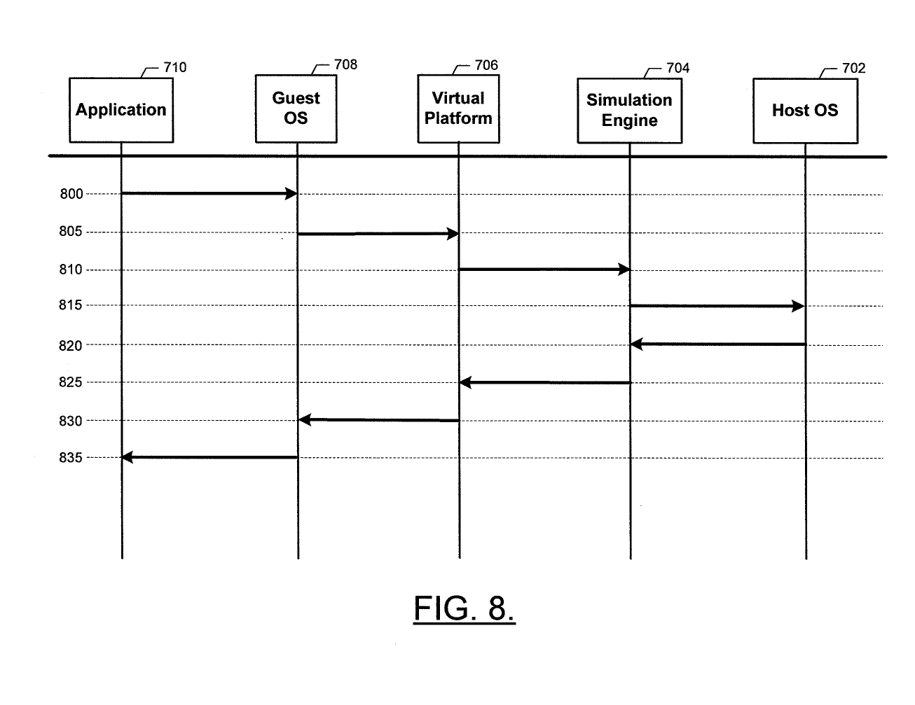

FIG. 7 illustrates a system for providing access to real time information according to an example embodiment of the present invention. The system of FIG. 7 comprises a simulation engine 704 running on top of a host operating system 702. A virtual platform 706 is run on top of the simulation engine 704. A guest operating system 708 (also referred to by way of example as a simulated binary) is run on top of the virtual platform 706. An application 710 is run on top of the guest operating system 708. In the embodiment of FIG. 7, a real time module 712 is implemented on the virtual platform 706. The real time module 712 may comprise at least a portion of the RTM circuitry 118 and will be referred to as such by way of example throughout the remainder of the description of FIG. 7 and the description of FIG. 8.

FIG. 8 illustrates a signaling diagram of signals that may be exchanged between elements of the system of FIG. 7 in accordance with an example embodiment of the present invention. During runtime of the application 710, the application 710 may need access to real time information. Accordingly, operation 800 may comprise the application 710 sending a request for real time to the guest operating system 708. The guest operating system 708 may then forward the request to the virtual platform 706, at operation 805. The request may be handled by the RTM circuitry 118, which may send a request for real time information to the simulation engine 704, at operation 815. Operation 820 may comprise the simulation engine 704 sending a request to the host operating system 702 for real time information in response to the request from the RTM circuitry 118. The host operating system 702 may respond to the request by providing real time information to the simulation engine 704, at operation 820. Operation 825 may comprise the simulation engine 704 forwarding the real time information to the virtual platform 706, where it may be handled by the RTM circuitry 118. The RTM circuitry 118 may determine the real time from the received real time information and provide the real time to the application 710 by sending an indication of the real time to the guest operating system 708, at operation 825. Operation 830 may comprise the guest operating system 708 forwarding the real time to the application 710, which may then utilize the received real time information.

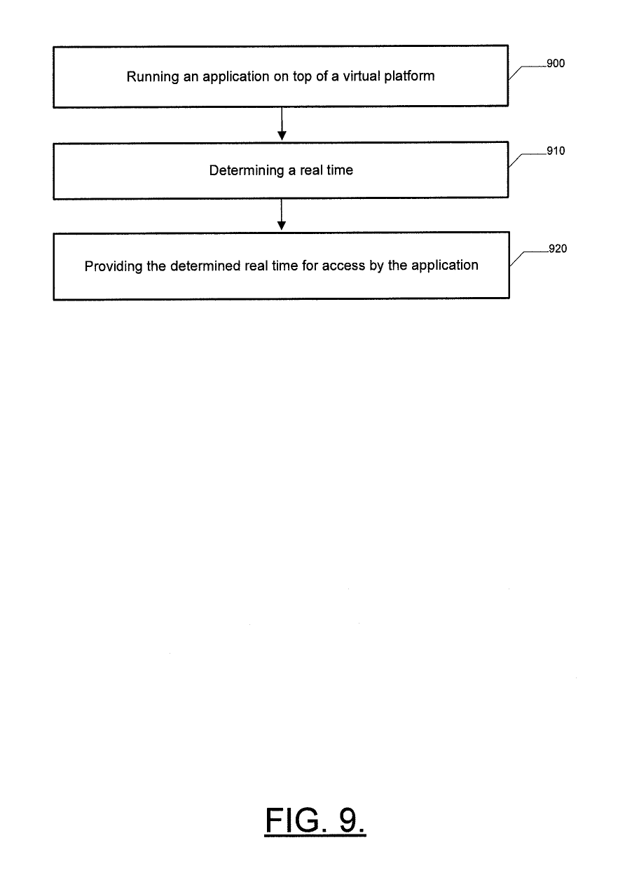

FIG. 9 illustrates a flowchart according to an example method for providing access to real time information according to an example embodiment of the invention. In this regard, FIG. 9 illustrates operations that may, for example, be performed at the apparatus 202. The operations illustrated and described with respect to FIG. 9 may, for example, be performed by and/or under control of the RTM circuitry 218 and/or processor 210. Operation 900 may comprise running an application on top of a virtual platform. Operation 910 may comprise determining a real time. Operation 920 may comprise providing the determined real time for access by the application.

FIG. 9 is a flowchart of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 202) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to computing devices and computing device users. In this regard, embodiments of the invention may be particularly beneficial in the area of software development in which an application is being run on top of a virtual platform. Some embodiments of the invention provide for determining a real time defining a non-simulation time that is maintained independently of the virtual platform such that the real time is not affected by performance of one or more of a virtual platform or an application running on top of the virtual platform. In this regard, the real time may be maintained by a host operating system on top of which the virtual platform is run or by a computing device external to the device on which the virtual platform is run such that the real time is not subjected to any slow down that may affect a simulation clock run on top of the virtual platform.

Some embodiments of the invention provide a determined real time for access by an application running on top of a virtual platform such that the real time may be used to more accurately evaluate performance of the application. For example, embodiments of the invention allow a more accurate calculation of application performance in terms of millions of instructions per second (MIPS) or other measure of application performance. In this regard, the rate of elapse of the real time maintained independently of the virtual platform by which application performance may be measured in accordance with embodiments of the invention is not affected by performance of the virtual platform, which may slow a rate of elapse of a simulated clock or timer run on top of the virtual platform.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
running an application on top of a virtual platform;
determining, by real time module circuitry, a real time, the real time defining a non-simulation time that is maintained independently of the virtual platform, wherein the real time is not affected by performance of the virtual platform or of the application running on top of the virtual platform; and
providing the determined real time for access by the application.

2. The method of claim 1, wherein determining the real time comprises determining a real time maintained by a host operating system on top of which the virtual platform is run.

3. The method of claim 1, wherein determining the real time comprises determining a real time maintained by an external apparatus.

4. The method of claim 1, further comprising:
maintaining an estimated real time clock using a simulated hardware clock implemented on top of the virtual platform; and wherein
determining the real time comprises synchronizing the maintained estimated real time clock with the determined real time.

5. The method of claim 1, wherein determining the real time comprises determining the real time at regularly scheduled intervals.

6. The method of claim 1, further comprising receiving a request originated by the application for the real time, and wherein determining the real time comprises determining the real time in response to the request originated by the application.

7. The method of claim 1, further comprising receiving at least a portion of a trace generated by the application, and wherein providing the determined real time for access by the application comprises stamping the trace with the real time and outputting the stamped trace.

8. The method of claim 1, further comprising receiving a request originated by the application for the real time, and wherein providing the determined real time for access by the application comprises providing the real time for access by the application in response to the request.

9. An apparatus comprising at least one processor and at least one memory storing computer program code, wherein the at least one memory and stored computer program code are configured to, with the at least one processor, cause the apparatus to at least:
run an application on top of a virtual platform;
determine a real time, the real time defining a non-simulation time that is maintained independently of the virtual platform, wherein the real time is not affected by performance of the virtual platform or of the application running on top of the virtual platform; and
provide the determined real time for access by the application.

10. The apparatus of claim 9, wherein the at least one memory and stored computer program code are configured to, with the at least one processor, cause the apparatus to determine the real time by determining a real time maintained by a host operating system on top of which the virtual platform is run.

11. The apparatus of claim 9, the at least one memory and stored computer program code are configured to, with the at least one processor, cause the apparatus to determine the real time by determining a real time maintained by an external apparatus.

12. The apparatus of claim 9, wherein the at least one memory and stored computer program code are configured to, with the at least one processor, further cause the apparatus to:
maintain an estimated real time clock using a simulated hardware clock implemented on top of the virtual platform; and wherein
the at least one memory and stored computer program code are configured to, with the at least one processor, cause the apparatus to determine the real time by synchronizing the maintained estimated real time clock with the determined real time.

13. The apparatus of claim 9, wherein the at least one memory and stored computer program code are configured to, with the at least one processor, cause the apparatus to determine the real time by determining the real time at regularly scheduled intervals.

14. The apparatus of claim 9, wherein the at least one memory and stored computer program code are configured to, with the at least one processor, further cause the apparatus to:
receive a request originated by the application for the real time; and
wherein the at least one memory and stored computer program code are configured to, with the at least one processor, cause the apparatus to determine the real time by determining the real time in response to the request originated by the application.

15. The apparatus of claim 9, wherein the at least one memory and stored computer program code are configured to, with the at least one processor, further cause the apparatus to:
receive at least a portion of a trace generated by the application; and
wherein the at least one memory and stored computer program code are configured to, with the at least one processor, cause the apparatus to provide the determined real time for access by the application by stamping the trace with the real time and outputting the stamped trace.

16. The apparatus of claim 9, wherein the at least one memory and stored computer program code are configured to, with the at least one processor, further cause the apparatus to:
receive a request originated by the application for the real time; and
wherein the at least one memory and stored computer program code are configured to, with the at least one processor, cause the apparatus to provide the determined real time for access by the application by providing the real time for access by the application in response to the request.

17. A computer program product comprising at least one computer-readable storage medium having computer-readable program instructions stored therein, the computer-readable program instructions comprising:
program instructions configured to run an application on top of a virtual platform;
program instructions configured to determine a real time, the real time defining a non-simulation time that is maintained independently of the virtual platform, wherein the real time is not affected by performance of the virtual platform or of the application running on top of the virtual platform; and
program instructions configured to provide the determined real time for access by the application.

18. The computer program product of claim 17, wherein the program instructions configured to determine the real time comprise program instructions configured to determine a real time maintained by a host operating system on top of which the virtual platform is run.

19. The computer program product of claim 17, wherein the program instructions configured to determine the real time comprise program instructions configured to determine a real time maintained by an external apparatus.

20. The computer program product of claim 17, further comprising program instruction configured to maintain an estimated real time clock using a simulated hardware clock implemented on top of the virtual platform; and wherein
program instructions configured to determine the real time comprise program instructions configured to synchronize the maintained estimated real time clock with the determined real time.
